(19) United States
(12) Patent Application Publication
(10) Pub. No.: US 2024/0085196 A1
(43) Pub. Date: Mar. 14, 2024

(54) TRAVEL PLANNING ASSISTANCE SYSTEM, METHOD, AND PROGRAM

(71) Applicant: NEC Corporation, Minato-ku, Tokyo (JP)

(72) Inventors: Asako FUJII, Tokyo (JP); Takuroh KASHIMA, Tokyo (JP)

(73) Assignee: NEC Corporation, Minato-ku, Tokyo (JP)

(21) Appl. No.: 18/274,909

(22) PCT Filed: Feb. 1, 2021
(86) PCT No.: PCT/JP2021/003513

§ 371 Date: Jul. 28, 2023

(51) Int. Cl. G01C 21/34; G06N 3/092

(52) U.S. Cl. CPC G01C 21/3446; G01C 21/343; G01C 21/3453; G06N 3/092

(57) ABSTRACT

A function input means 71 accepts input of a cost function that calculates a cost incurred by an itinerary, the cost function being expressed as a linear sum of terms weighted for each feature that a traveler is expected to intend in the itinerary. A learning means 72 learns the cost function by inverse reinforcement learning using training data that includes scheduled information indicating travel planning of the traveler, attribute information indicating an attribute of the traveler, and actual information indicating an actual travel result of the traveler. A data extraction means 73 extracts the training data whose specified attribute matches the attribute information. Then, the learning means 72 learns the cost function according to the attributes by inverse reinforcement learning using the extracted training data.

### TECHNICAL FIELD

This invention relates to a travel planning assistance system, a travel planning assistance method, and a travel planning assistance program that assist generating of travel planning.

### BACKGROUND ART

Travel planning is generated by considering a variety of factors. Guidebooks, social networking services (SNS), and route-finding applications are used during planning, and ultimately, these various tools are used to determine the traveler's optimal travel planning. In some cases, travel planning may be requested from travel agency representatives in order to determine a more favorable travel planning.

In addition, Patent Literature 1 describes a method for easily searching a route via a via-point, such as a tourist spot. In the method described in Patent Literature 1, when displaying a plurality of via-points including a first via-point and a second via-point, other via-point candidates that are alternatives to the first via-point or second transit point are displayed. Specifically, when another candidate via-point is selected as an alternative to the first via-point or second via-point, the travel route is displayed with the selected candidate via-point replaced with the corresponding via-point, without changing the points before or after the selected other candidate via-point.

With regard to travel planning, various methods for planning efficient routes are also known. For example, Patent Literature 2 describes a road learning model generating device and a delivery planning generating device that support delivery of multiple packages to be delivered. The road learning model generating device described in Patent Literature 2 uses inverse reinforcement learning to generate a road learning model that calculates road costs, which indicate delivery efficiency during road travel, for each road based on the driving history of a skilled driver, road network information, and road features. The delivery planning generating device then generates an optimal delivery planning using the generated road learning model.

### CITATION LIST

### Patent Literature

PTL 1: Japanese Patent Application Laid-Open No. 2018-155519
PTL 1: International Publication 2019/082720.

### SUMMARY OF INVENTION

### Technical Problem

In the general method, travelers make travel planning one at a time, but in this method, there is a risk of missing a more appropriate travel planning. In addition, if the traveler asks a travel agent's representative, the possibility of being presented with a more favorable travel planning is increased, but the possibility that the planning may include the representative's own personalities or arbitrary recommendations cannot be denied. The same is true when referring to guidebooks.

Using the method described in Patent Literature 1, it is possible to search for a candidate route via a specified tourist spot. However, a candidate route is not necessarily a route that represents an appropriate itinerary for the traveler. Therefore, it is difficult to reduce the traveler's burden because the traveler must consequently evaluate each candidate route one by one.

It is also possible to plan routes in accordance with the ideas of skilled drivers by using the road learning model described in Patent Literature 2. However, the road learning model generated by the method described in Patent Literature 2 is used to derive a delivery plan that reduces the delivery burden on drivers. In other words, it is difficult to apply the above road learning model to travel planning as it is, because it is a model that emphasizes efficiency in terms of time and distance.

For example, travel planning is not necessarily concerned only with efficiency, for example, if there is a place to go via, even if it takes more time or distance, that place should be selected. The method described in the Patent Literature 2 may miss what should be considered in such a travel.

It is therefore an object of the present invention to provide a travel planning assistance system, a travel planning assistance method, and a travel planning assistance program that can assist in generating an appropriate travel planning for a traveler.

### Solution to Problem

The travel planning assistance system according to the present invention includes: a function input means which accepts input of a cost function that calculates a cost incurred by an itinerary, the cost function being expressed as a linear sum of terms weighted for each feature that a traveler is expected to intend in the itinerary; a learning means which learns the cost function by inverse reinforcement learning using training data that includes scheduled information indicating travel planning of the traveler, attribute information indicating an attribute of the traveler, and actual information indicating an actual travel result of the traveler; and a data extraction means which extracts the training data whose specified attribute matches the attribute information, wherein the learning means learns the cost function according to the attributes by inverse reinforcement learning using the extracted training data.

The travel planning assistance method according to the present invention includes: accepting input of a cost function that calculates a cost incurred by an itinerary, the cost function being expressed as a linear sum of terms weighted for each feature that a traveler is expected to intend in the itinerary; learning the cost function by inverse reinforcement learning using training data that includes scheduled information indicating travel planning of the traveler, attribute information indicating an attribute of the traveler, and actual information indicating an actual travel result of the traveler; extracting the training data whose specified attribute matches the attribute information; and learning the cost function according to the attributes by inverse reinforcement learning using the extracted training data.

The travel planning assistance program for causing a computer to execute: function input processing to accept input of a cost function that calculates a cost incurred by an itinerary, the cost function being expressed as a linear sum of terms weighted for each feature that a traveler is expected to intend in the itinerary; learning processing to learn the cost function by inverse reinforcement learning using training data that includes scheduled information indicating travel planning of the traveler, attribute information indicating an attribute of the traveler, and actual information indicating an actual travel result of the traveler; and data extraction processing to extract the training data whose specified attribute matches the attribute information, wherein, in the learning processing, the cost function is learned according to the attributes by inverse reinforcement learning using the extracted training data.

### Advantageous Effects of Invention

According to the invention, it can assist in generating appropriate travel planning for travelers.

### BRIEF DESCRIPTION OF DRAWINGS

FIG. 1 It depicts a block diagram showing a configuration example of a first exemplary embodiment of a travel planning assistance system according to the present invention.

FIG. 2 It depicts an explanatory diagram showing an example of planning data.

FIG. 3 It depicts a flowchart showing an example of the operation of a learning device of the first exemplary embodiment.

FIG. 4 It depicts a flowchart showing an example of the operation of a travel planning output device of the first exemplary embodiment.

FIG. 5 It depicts a block diagram showing a configuration example of a second exemplary embodiment of a travel planning assistance system according to the present invention.

FIG. 6 It depicts a flowchart showing an example of the operation of a learning device of the second exemplary embodiment.

FIG. 7 It depicts a flowchart showing an example of the operation of a travel planning output device of the second exemplary embodiment.

FIG. 8 It depicts an explanatory diagram showing an example of the process of generating a travel planning.

FIG. 9 It depicts an explanatory diagram showing an example of the application of the travel planning assistance system.

FIG. 10 It depicts a block diagram showing an overview of the travel planning assistance system according to the present invention.

### DESCRIPTION OF EMBODIMENTS

Hereinafter, exemplary embodiments of the present invention will be described with reference to the drawings.

### Exemplary Embodiment 1

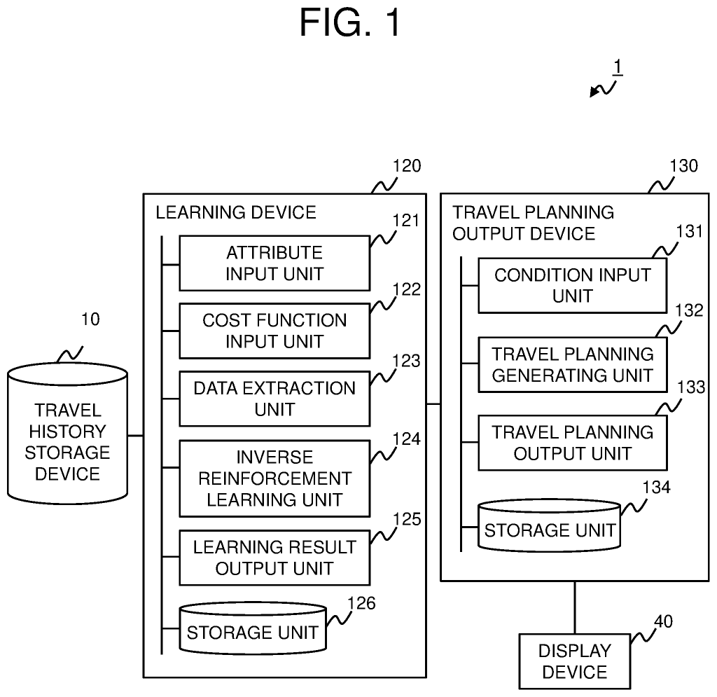

FIG. 1 a block diagram showing a configuration example of a first exemplary embodiment of a travel planning assistance system according to the present invention. The travel planning assistance system of the first exemplary embodiment generates a cost function to be used in making a travel planning that is assumed to be desirable for the gender and age specified by the user making the travel planning, and generates the travel planning appropriate for the user using that cost function. The details of the cost function are described below.

The first exemplary embodiment of the travel planning assistance system 1 includes a travel history storage device 10, a learning device 120, a travel planning output device 130, and a display device 40.

The display device 40 is a device that outputs the results of various processes by the travel planning assistance system 1. The display device 40 is realized, for example, by a display device. Although FIG. 1 shows an example of one display device 40 connected to the travel planning output device 130, the display device 40 connected to the learning device 120 and the display device 40 connected to the travel planning output device 130 may be provided separately.

The travel history storage device 10 stores the traveler's past travel history (hereinafter referred to as “planning data”). The planning data in this exemplary embodiment includes not only information on actual travels taken, but also the planned information made at the planning stage. The planning data also includes information indicating the traveler's attributes and the traveler's evaluation.

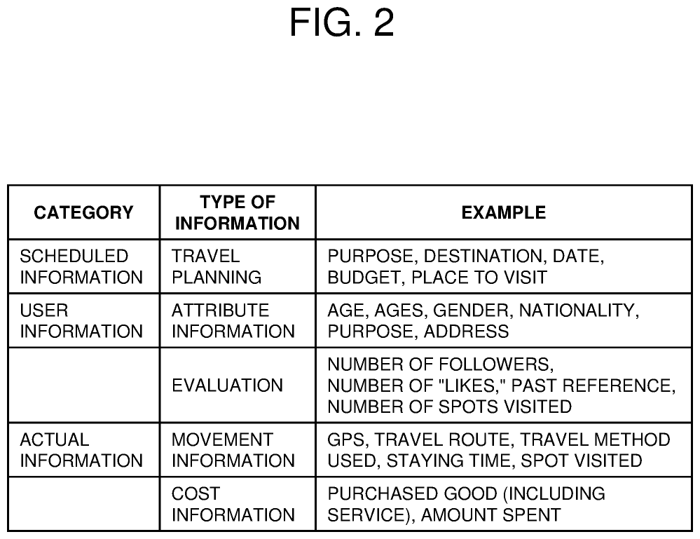

FIG. 2 is an explanatory diagram showing an example of planning data. The planning data illustrated in FIG. 2 includes items that are classified into three major categories (scheduled information, user information, and actual information). The scheduled information is information that is assumed in the travel planning of the traveler, and actual information is information that indicates an actual travel result of the traveler based on the travel planning. The user information indicates the attributes of the person who made the travel planning, and is also used to identify the person who is assumed to be an expert, as described below. The information including the scheduled information and actual information may be referred to as itinerary or itinerary information.

The planning data illustrated in FIG. 2 is an example, and the planning data may include all or some of the items illustrated in FIG. 2. The planning data may include items other than those illustrated in FIG. 2. For example, the actual information may include information indicating the environment, such as weather. The planning data may be created and collected using, for example, a dedicated application or an existing SNS.

The learning device 120 includes an attribute input unit 121, a cost function input unit 122, a data extraction unit 123, an inverse reinforcement learning unit 124, a learning result output unit 125, and a storage unit 126.

The attribute input unit 121 accepts input of attributes of the expert desired by the user for travel planning. The attribute input unit 121 may, for example, accept input of attributes such as gender and age. The attribute input unit 121 may also accept input of information indicating a specific user (e.g., influencer) as an attribute.

The expert in this exemplary embodiment refers to a person who is considered to be able to realize an itinerary that is considered appropriate for the traveler. Appropriateness here does not necessarily mean efficiency alone, but includes comfort, preference, and other conditions that may give a favorable impression to the user. For example, if “20s” is specified as an attribute, a person in his/her 20s who is used to traveling is assumed to be specified and processed.

The cost function input unit 122 accepts input of a cost function that calculates a cost incurred in an itinerary as a cost function used for learning by the inverse reinforcement learning unit 124 described below. Specifically, the cost function input unit 122 accepts input of the cost function expressed as a linear sum of terms in which the degree of importance is weighted for each feature that is assumed to be intended by the traveler in the itinerary (i.e., various information in the scheduled information and actual information), as contained in the planning data shown in FIG. 2.

The degree of importance can be said to represent the user's intention for the itinerary. Therefore, the value calculated by the cost function can be said to be an evaluation indicator used to evaluate the itinerary. The cost function used in this exemplary embodiment can also be said to be a planning design model, since it is a model used by the travel planning output device 130 (described below) to design planning, and is a model that has learned what policies the itinerary actually adopted was based on.

The cost function input unit 122 may also accept input of a constraint condition to be satisfied along with the cost function. The cost function and the constraint condition are predefined by the analyst or others. That is, candidates of features to be considered in the itinerary are selected in advance by the analyst, etc. and defined as the cost function.

For example, if moving time evaluation and location evaluation are considered as items (features) intended by the expert when evaluating an itinerary, the cost function for calculating the optimization index is represented by Equation 1, illustrated below. xᵢⱼ and zᵢ in Equation 1 represent the features.

[Math. 1]

Optimization index=Σᵢⱼαᵢdᵢⱼxᵢⱼ−Σᵢβᵢzᵢ (Equation 1)

In Equation 1, xᵢⱼ indicates whether or not to move from location i to location j. Specifically, xᵢⱼ=1 if moving from location i to location j and xᵢⱼ=0 if not moving from location i to location j. In addition, dᵢⱼ indicates the moving time from location i to location j, and zᵢ indicates the degree of evaluation of location i. In other words, the cost function shown in Equation 1 above can be said to be a function in which the longer the moving time, the higher the cost (value) is calculated, and the higher the evaluation of the travel location (location), the lower the cost (value) is calculated.

The features shown above are examples and may include other features. For example, a feature is a staying time at each location. The cost function may be defined as a function where the longer the staying time, the lower the cost (value) is calculated. The features that are less relevant to the travel planning are set to lower weights as a result of inverse reinforcement learning, resulting in the extraction of the features intended by the expert in the travel planning.

The data extraction unit 123 extracts planning data from the travel history storage device 10 that corresponds to the attributes received by the attribute input unit 121. For example, if the travel history storage device 10 stores the planning data illustrated in FIG. 2, the data extraction unit 123 may extract the planning data whose accepted attributes match the user information (attribute information). Since the extracted planning data is the data used for training by the inverse reinforcement learning unit 124 described below, the extracted planning data may be referred to as training data.

When the travel history storage device 10 stores planning data of a person other than the expert described above, the data extraction unit 123 may extract planning data of a person who satisfies the predefined expert condition. This makes it possible to use the information of the travel history storage device 10, which stores planning data of any person, as training data for the inverse reinforcement learning described below.

The method of extracting planning data of the expert is arbitrary and is predetermined by the analyst or others. For example, the data extraction unit 123 may extract planning data of a person who has made many travels, who is highly rated by others, who has created inexpensive itineraries, who has visited many spots (tourist spots), who has visited the same spots many times, who has many followers on a SNS, and so on, as the expert, and the planning data of such persons may be extracted as the planning data of the expert.

The data extraction unit 123 may also perform processes to convert items in the planning data to features (e.g., arithmetic operations, conversion to binary values, etc.), data integration, data cleansing, etc., in order to match the features included in the cost function.

The inverse reinforcement learning unit 124 learns the cost function described above by inverse reinforcement learning using the training data extracted by the data extraction unit 123. Specifically, the inverse reinforcement learning unit 124 learns the cost function by inverse reinforcement learning using the planning data of the expert corresponding to the accepted attribute as training data. That is, this training data includes information representing the content of the expert's itinerary (specifically, scheduled information indicating the traveler's travel planning and attribute information indicating the traveler's attributes, as well as actual information indicating the traveler's travel results).

The method by which the inverse reinforcement learning unit 124 performs inverse reinforcement learning is arbitrary. For example, the inverse reinforcement learning unit 124 may learn the cost function by repeatedly performing a mathematical optimization process to generate a expert's itinerary based on the input cost function and constraint conditions, and a cost function estimation process to update the parameters of the cost function (degree of importance) so that the difference between the generated expert's itinerary and training data is reduced.

When the inverse reinforcement learning unit 124 learns a cost function by inverse reinforcement learning using the planning data, it is possible to extract features related to the itinerary. This makes it possible to generate an optimal travel planning by considering various features.

The learning result output unit 125 outputs the learned cost function. Specifically, the learning result output unit 125 outputs the features included in the cost function for the specified attribute, and the weights of the features are associated with the features. The learning result output unit 125 may store the learned cost function in the storage unit 126, or may transmit the cost function information to the travel planning output device 130 for storage in the storage unit 134.

The learning result output unit 125 may also display the contents of the cost function on the display device 40. By displaying the contents of the cost function on the display device 40, it becomes possible to visually recognize the items that are emphasized by the expert in the itinerary.

The storage unit 126 stores the learned cost function. The storage unit 126 may also store various parameters used by the inverse reinforcement learning unit 124 for learning. The storage unit 126 is realized by, for example, a magnetic disk.

The attribute input unit 121, the cost function input unit 122, the data extraction unit 123, the inverse reinforcement learning unit 124, and the learning result output unit 125 are implemented by a processor (for example, a central processing unit (CPU)) of a computer that operates according to a program (learning program, travel planning assistance program).

For example, the program may be stored in the storage unit 126 of the learning device 120, and the processor may read the program and operate as the attribute input unit 121, the cost function input unit 122, the data extraction unit 123, the inverse reinforcement learning unit 124, and the learning result output unit 125 according to the program. Furthermore, the function of the learning device 120 may be provided in a software as a service (SaaS) format.

The attribute input unit 121, the cost function input unit 122, the data extraction unit 123, the inverse reinforcement learning unit 124, and the learning result output unit 125 may be implemented by dedicated hardware. In addition, some or all of the components of each device may be implemented by general-purpose or dedicated circuitry, a processor, or the like, or a combination thereof. These may be configured by a single chip or may be configured by a plurality of chips connected via a bus. Some or all of the components of each device may be implemented by a combination of the above-described circuit or the like and a program.

In addition, in a case where some or all of the components of the learning device 120 are implemented by a plurality of information processing devices, circuits, and the like, the plurality of information processing devices, circuits, and the like may be disposed in a centralized manner or in a distributed manner. For example, the information processing device, the circuit, and the like may be implemented as a mode in which the same are connected to each other via a communication network such as a client server system and a cloud computing system.

The travel planning output device 130 includes a condition input unit 131, a travel planning generating unit 132, a travel planning output unit 133, and a storage unit 134.

The storage unit 134 stores various information that is used by the travel planning generating unit 132 (described below) to generate the travel planning. For example, the storage unit 134 stores relevant information such as locations that are candidates for travel points in the target region, means of transportation, and moving time between two points using each means of transportation. The storage unit 134 may also store the cost function learned by the learning device 120. The storage unit 134 is realized by, for example, a magnetic disk.

The condition input unit 131 accepts input of a constraint condition when planning a travel. Specifically, the condition input unit 131 accepts input of a constraint condition for generating the travel planning. Examples of the constraint condition include, for example, a combination of start point and goal point, information on places to be visited on a mandatory basis, candidate travel points, staying time, and cost.

The condition input unit 131 may also accept input of related information such as moving time between two locations together. The condition input unit 131 may, for example, retrieve the relevant information from the storage unit 134.

The travel planning generating unit 132 generates a travel planning with the minimum cost calculated by the cost function described above among the travel planning that travel to each of the candidate travel points to satisfy the input constraint conditions. Specifically, the travel planning generating unit 132 generates the travel planning by seeking a combination of travel or stay with the minimum cost based on a set of candidate travel points, such as sightseeing spots, and the cost incurred in moving to the candidate travel point or staying at the candidate travel point.

The method by which travel planning generating unit 132 seeks combinations of travels or stays with the minimum cost is arbitrary. The travel planning generating unit 132 may generate the travel planning as a combinatorial optimization problem. For example, the travel planning generating unit 132 may generate the travel planning as a problem of solving for the path with the minimum cost, using the cost calculated by the cost function instead of the distance used in the Dijkstra method algorithm.

The travel planning output unit 133 outputs the generated travel planning. The travel planning output unit 133 outputs as a travel planning, for example, various information that can realize a travel, such as the travel point and means of travel, time required for travel, and staying time. The travel planning output unit 133 may also output the travel information (e.g., travel route, moving time, staying time, etc.) between each travel point included in the travel planning, superimposed on a map. This makes it possible to grasp the output travel planning more concretely.

The condition input unit 131, the travel planning generating unit 132, and the travel planning output unit 133 are realized by a computer processor (e.g., CPU) that operates according to a program (travel planning output program, travel planning assistance program).

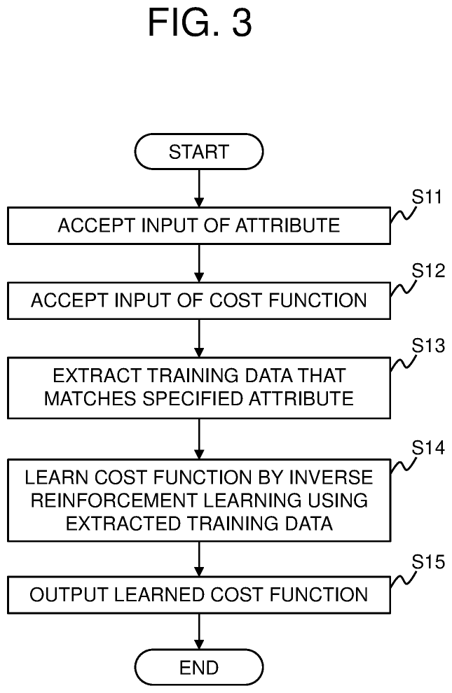

Next, the operation of this exemplary embodiment of the travel planning assistance system will be described. FIG. 3 is a flowchart showing an example of the operation of the learning device 120 of this exemplary embodiment. The attribute input unit 121 accepts input of attributes desired by the user for travel planning (step S11). The cost function input unit 122 accepts input of a cost function that calculates the costs incurred by an itinerary (step S12). The data extraction unit 123 extracts training data whose specified attributes match the attribute information (step S13). The inverse reinforcement learning unit 124 learns the cost function by inverse reinforcement learning using the extracted training data (step S14). The learning result output unit 125 outputs the learned cost function (step S15).

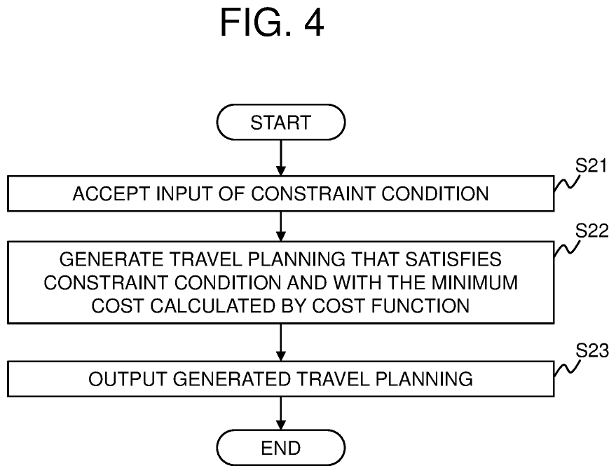

FIG. 4 is a flowchart showing an example of the operation of a travel planning output device 130 of this exemplary embodiment.

The condition input unit 131 accepts input of constraint conditions for generating a travel planning (step S21). The travel planning generating unit 132 generates a travel planning with the minimum cost calculated by the cost function among the travel planning set up to travel to each candidate travel point to satisfy the constraint conditions (step S22). The travel planning output unit 133 then outputs the generated travel planning (step S23).

As described above, in this exemplary embodiment, the cost function input unit 122 accepts input of a cost function that calculates a cost incurred by an itinerary, and the data extraction unit 123 extracts training data whose specified attribute matches the attribute information. The inverse reinforcement learning unit 124 learns the cost function by inverse reinforcement learning using the extracted training data. Thus, it can assist in generating appropriate travel planning for travelers.

For example, when sightseeing in a certain city, the general method is to determine the places to visit based on the Internet, guidebooks, etc., and then determine the means to get to the determined places in a stacked manner. For example, if you want to go from point A to point C via point B on the way, you may decide to take a train from point A to point B based on the guidebook, and decide to take a cab from point B to point C based on the map application.

However, although it is possible to determine the optimal route and time required to reach a destination, including transit points, using general methods, it is difficult to determine the appropriate route when traveling to multiple points, including the staying time at each point. For example, consider a situation where there is an hour available for a layover and you want to travel to a certain point. Using the general method, the moving time required to go from the meeting place to a certain point and back can be ascertained, but it is difficult to ascertain an appropriate plan that includes the staying time (including, for example, time to settle up), and it is undeniable that there may be a situation where time may be in short supply.

On the other hand, in the travel planning assistance system of this exemplary embodiment, the inverse reinforcement learning unit 124 generates a model from the expert's past planning data by inverse reinforcement learning. Then, the travel planning generating unit 132 outputs a travel planning reflecting the expert's intention by using that cost function. This makes it possible to generate a travel planning that takes into account factors other than moving time.

Also, in this exemplary embodiment, the data extraction unit 123 extracts planning data corresponding to the accepted attributes from the travel history storage device 10, and a cost function is generated using the extracted planning data. The travel planning output device 130 then generates a travel planning using the generated cost function. This can be said to be matching with a person similar to the specified attribute (i.e., yourself), which also makes it possible to obtain a travel planning that matches your own interests and preferences.

Furthermore, because the data extraction unit 123 narrows down the planning data, for example, the travel history of any person who has traveled based on the generated travel planning can also be reused as planning data.

In addition, guidebooks can only provide a partial list of recommendations and are susceptible to elapsed years. In addition, if many travelers follow a guidebook, they may concentrate on the places listed in the guidebook. On the other hand, in this exemplary embodiment, the learning device 120 learns a cost function that indicates travelers' intentions from past planning data. For example, by limiting the training data to local people or by updating the model more frequently, it is possible to generate real-time travel planning.

In addition, good travel is difficult to define, making it difficult for travelers to search for appropriate information. For example, travel planning by an expert (someone who is used to traveling) may be difficult for an elderly person or a beginner. On the other hand, in this exemplary embodiment, the inverse reinforcement learning unit 124 learns a cost function based on planning data according to the specified attribute, thus making it possible to generate an appropriate travel planning according to that attribute.

In addition, the inverse reinforcement learning unit 124 learns a cost function specifically for planning data by a particular person (e.g., influencer X). Thus, it is possible to provide a pseudo-travel plan for that influencer (e.g., “X would follow this travel route”).

In addition, because the cost function is learned from training data in this exemplary embodiment, it is no longer necessary to prepare a so-called master, which defines the travel planning, and the maintenance cost of individual information for that master can be controlled.

### Exemplary Embodiment 2

Next, a second exemplary embodiment of the travel planning assistance system will be described. The travel planning assistance system of the second exemplary embodiment generates a plurality of cost functions in advance, and by having the user making a travel planning select a cost function for the desired genre, the system generates an appropriate travel planning in the selected genre.

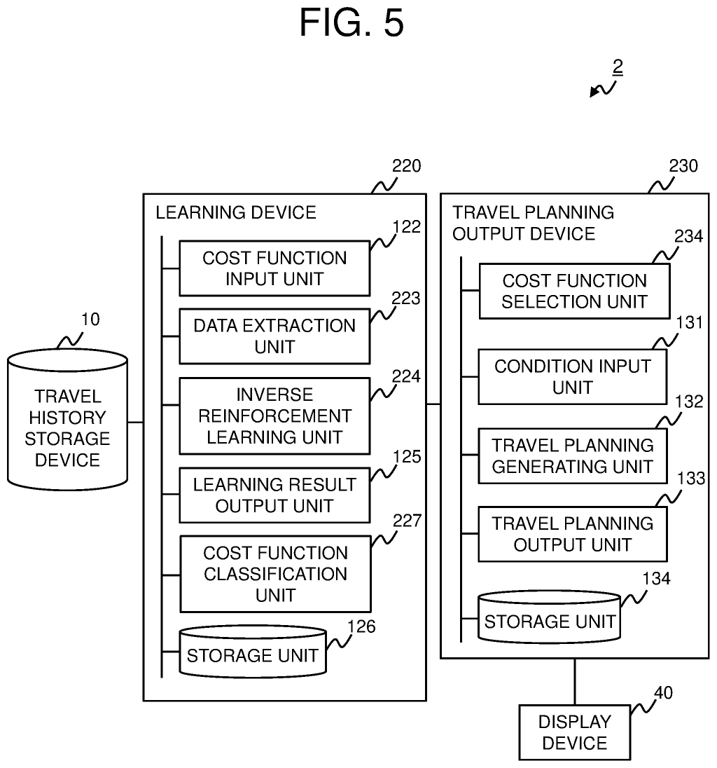

FIG. 5 is a block diagram showing a configuration example of a second exemplary embodiment of a travel planning assistance system according to the present invention. The travel planning assistance system 2 of the second exemplary embodiment includes a travel history storage device 10, a learning device 220, a travel planning output device 230, and a display device 40. The contents of the travel history storage device 10 and the display device 40 are the same as in the first exemplary embodiment.

The learning device 220 includes a cost function input unit 122, a data extraction unit 223, an inverse reinforcement learning unit 224, a learning result output unit 125, a storage unit 126, and a cost function classification unit 227. The contents of the cost function input unit 122, the learning result output unit 125, and the storage unit 126 are the same as in the first exemplary embodiment. The learning device 220 may include the attribute input unit 121 of the first exemplary embodiment.

The data extraction unit 223 extracts planning data from the travel history storage device 10. The data extraction unit 223 of this exemplary embodiment extracts planning data from the travel history storage device 10 based on predetermined rules. For example, the data extraction unit 223 of this exemplary embodiment may randomly extract a predetermined number of planning data, or may extract planning data for each age range. The extracted planning data is used for the learning process in the inverse reinforcement learning unit 224 described below.

The inverse reinforcement learning unit 224 learns multiple cost functions using the extracted planning data as training data. The method of learning cost functions is the same as in the first exemplary embodiment. The method of generating multiple cost functions is arbitrary. For example, a plurality of groups of planning data may be extracted by the data extraction unit 223, and a cost function based on the planning data may be learned for each of them using the planning data for each extracted group.

The cost function classification unit 227 classifies each learned cost function. Specifically, the cost function classification unit 227 sets information that can identify the contents of each learned cost function (hereinafter sometimes referred to as “label”). The cost function classification unit 227 may set labels that indicate the content of the feature with the highest weight set for each cost function. For example, in the case of a cost function with the highest weight set on travel distance, the cost function classification unit 227 may set a label such as “travel distance-oriented travel planning (model)” for that cost function. For example, in the case of a cost function with the highest weight set on food-related features, the cost function classification unit 227 may set a label such as “food-oriented travel planning (model)” for that cost function.

Otherwise, the cost function classification unit 227 may set a label indicating the characteristics of the cost function based on the refinement criteria for extracting planning data (training data). For example, if age is specified as an attribute, the cost function classification unit 227 may set a label such as “travel planning for XX generation” for that cost function.

The cost function classification unit 227 may also accept input of labels to be set for each cost function based on explicit instructions from the analyst. The analyst may instruct to set a label for each cost function based on the output result from the learning result output unit 125, for example.

The learning result output unit 125 may output the learned cost function along with the set labels.

The cost function input unit 122, the data extraction unit 223, the inverse reinforcement learning unit 224, the learning result output unit 125, and the cost function classification unit 227 are implemented by a processor of a computer that operates according to a program (learning program, travel planning assistance program).

The travel planning output device 230 includes a condition input unit 131, a travel planning generating unit 132, a travel planning output unit 133, and a cost function selection unit 234. The contents of the condition input unit 131, the travel planning generating unit 132, and the travel planning output unit 133 are the same as in the first exemplary embodiment.

The cost function selection unit 234 accepts the user's selection of a cost function. Specifically, the cost function selection unit 234 presents labels set for each cost function to the user and accepts the selection from the user. Thereafter, the travel planning generating unit 132 generates a travel planning based on the input constraint conditions and the selected cost function, as in the first exemplary embodiment.

The condition input unit 131, the travel planning generating unit 132, the travel planning output unit 133, and the cost function selection unit 234 are implemented by a processor of a computer that operates according to a program (travel planning output program, travel plan assistance program).

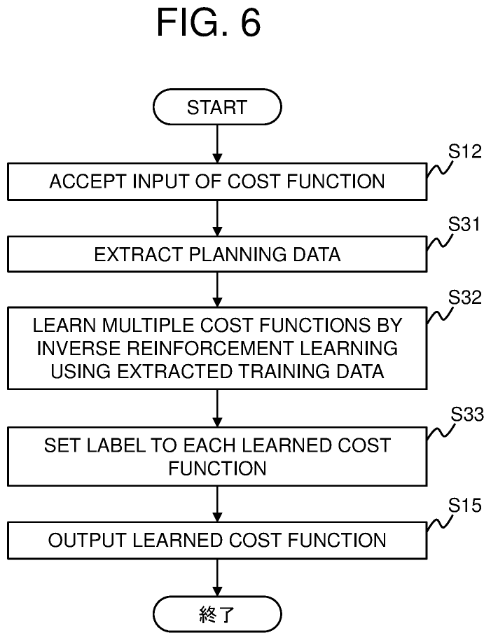

Next, the operation of this exemplary embodiment of the travel planning assistance system will be described. FIG. 6 is a flowchart showing an example of the operation of a learning device 220 of this exemplary embodiment. The process in which the cost function input unit 122 accepts cost function input is similar to the process in step S12 illustrated in FIG. 3. The data extraction unit 223 extracts planning data from the travel history storage device 10 (step S31).

The inverse reinforcement learning unit 224 learns multiple cost functions by inverse reinforcement learning using the extracted training data (step S32). The cost function classification unit 227 sets labels to each learned cost function (step S33). Thereafter, the process by which the learning result output unit 125 outputs the learned cost functions is the same as the process in step S15 illustrated in FIG. 3.

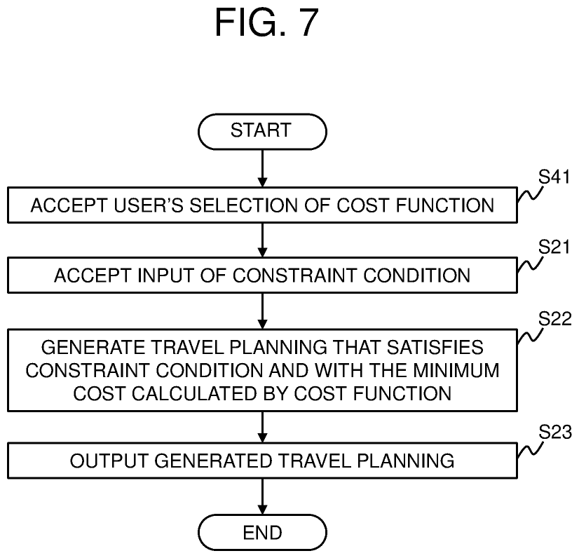

FIG. 7 is a flowchart showing an example of the operation of a travel planning output device 230 of this exemplary embodiment.

The cost function selection unit 234 accepts the user's selection of a cost function (step S41). Thereafter, the process from accepting the input of constraint conditions to generating and outputting the travel planning is similar to the process from step S21 to step S23 illustrated in FIG. 4.

As described above, in this exemplary embodiment, compared to the first exemplary embodiment, the inverse reinforcement learning unit 224 learns multiple cost functions, and the cost function selection unit 234 accepts the user's selection of the cost function. Such a configuration makes it possible to generate a travel planning according to the features that the user values.

The operation of the travel planning assistance system of the present invention will be described below using specific examples. In this specific example, a user in his/her 20s is traveling to City A, and the travel planning assistance system 1 of the first exemplary embodiment generates a travel planning as intended for a traveler of the same age.

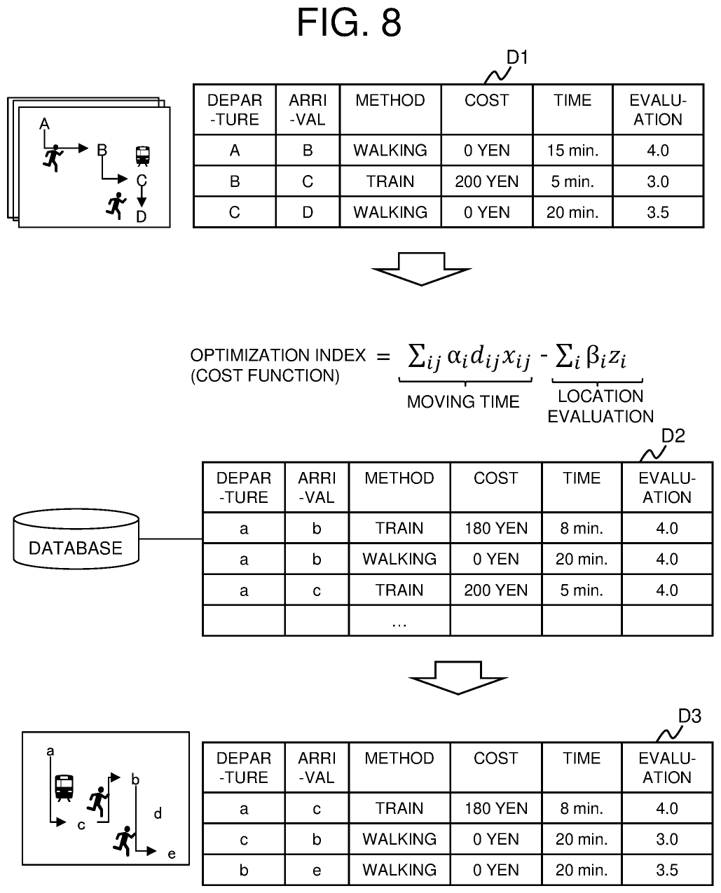

FIG. 8 is an explanatory diagram showing an example of the process of generating a travel planning. First, when the attribute input unit 121 accepts input of the traveler's attribute (20s) as an attribute, the data extraction unit 123 extracts the past planning data D1 of the traveler (20s) as illustrated in FIG. 8. The cost function input unit 122 accepts input of the cost function of Equation 1 as illustrated above. The inverse reinforcement learning unit 124 generates a cost function from which weights (αᵢ, βᵢ) that minimize the optimization index are derived by inverse reinforcement learning, and the learning result output unit 125 outputs the learned cost function. For example, a small value of a indicates that less importance is placed on time, while a large value of β indicates that more importance is placed on location evaluation.

Next, the condition input unit 131 accepts input of a constraint condition when travel planning. The condition input unit 131 also accepts input of relevant information D2 in city A. The travel planning generating unit 132 applies the relevant information D2, which is a candidate for the current visit, to a cost function that learns the intention of an expert (in this case, an expert in his twenties) to generate a travel planning that is in line with the intention of the expert. For example, if travel planning D3 is generated, it can be said that the travel planning to visit a, c, b, and e in that order is closest to the expert's intention.

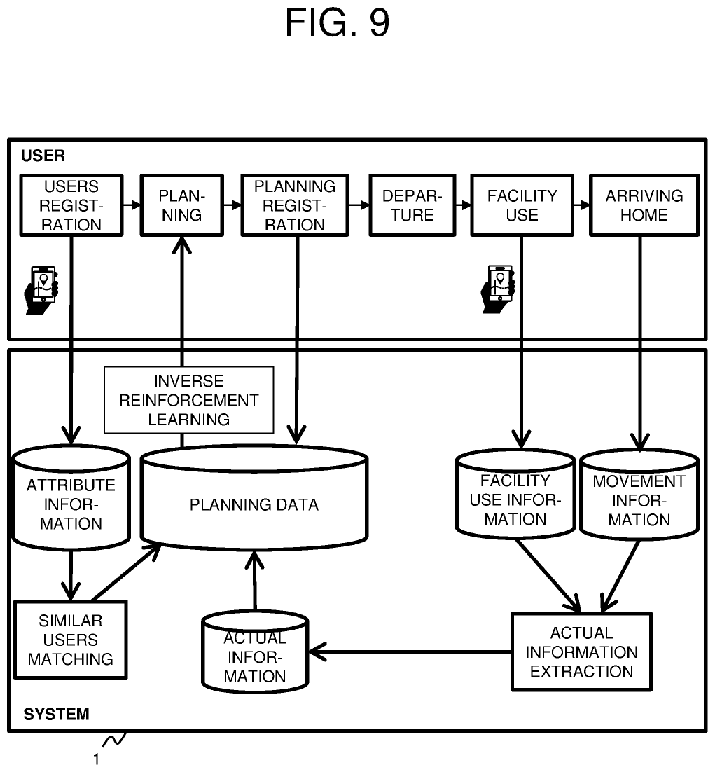

Next, examples of applications of the travel planning assistance system will be described. Again, the operation of the first exemplary embodiment of the travel planning assistance system 1 is illustrated. FIG. 9 is an explanatory diagram showing an example of the application of the travel planning assistance system.

The travel planning assistance system 1 accepts user registration from the user via, for example, a smartphone. Through this user registration, attribute information is extracted. The travel planning assistance system 1 performs matching of similar users based on this attribute information, extracts the relevant data from the planning data, and performs inverse reinforcement learning. The travel planning assistance system 1 then generates a travel planning using the generated cost function.

The user makes a travel planning based on the generated travel planning and registers the actual plan with the travel planning assistance system 1. The user then departs on the travel. After the departure, when the history of the user's use of facilities and travel data to return home are collected, the travel planning assistance system 1 extracts actual information from the history and registers the extracted actual information as new planning data.

By allowing actual information to accumulate in such a cycle, more appropriate travel planning can be generated and real-time travel planning can be generated.

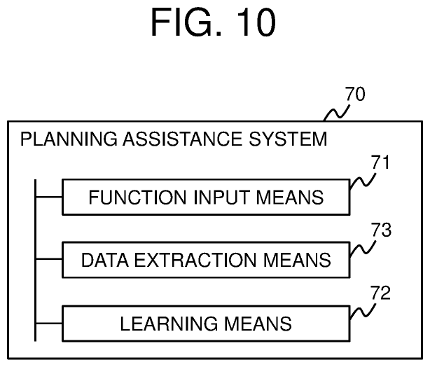

The following is an overview of the present invention. FIG. 10 is a block diagram showing an overview of the travel planning assistance system according to the present invention. The planning assistance system 70 (e.g., travel planning assistance system 1) according to the present invention includes a function input means 71 (e.g., cost function input unit 122) which accepts input of a cost function that calculates a cost incurred by an itinerary, the cost function being expressed as a linear sum of terms weighted for each feature that a traveler is expected to intend in the itinerary, a learning means 72 (e.g., inverse reinforcement learning unit 124) which learns the cost function by inverse reinforcement learning using training data that includes scheduled information indicating travel planning of the traveler, attribute information indicating an attribute of the traveler, and actual information indicating an actual travel result of the traveler, and a data extraction means 73 (e.g., data extraction unit 123) which extracts the training data whose specified attribute matches the attribute information.

The learning means 72 learns the cost function according to the attributes by inverse reinforcement learning using the extracted training data.

Such a structure can assist in generating appropriate travel planning for travelers.

The planning assistance system 70 may also include a condition input means (e.g., condition input unit 131) which accepts input of a constraint condition for generating the travel planning, and a travel planning generating means (e.g., travel planning generating unit 132) which generates the travel planning with the minimum cost calculated by the cost function among the travel planning set up to travel to each candidate travel point to satisfy the constraint condition.

Specifically, the travel planning generating means may generate the travel planning by seeking a combination of move or stay with the minimum total cost (e.g, as a combination problem) based on the set of the candidate travel points and the cost incurred in moving to or staying at the candidate travel points calculated by the cost function.

The planning assistance system 70 may also include a travel planning output means (e.g., travel planning output unit 133) which outputs move information between each travel point included in the travel planning superimposed on a map.

The planning assistance system 70 may also include a learning result output means (e.g., learning result output unit 125) which outputs a feature included in the cost function and weight of the feature in correspondence with the weight of the feature.

The planning assistance system 70 (e.g., travel planning assistance system 2) may include a cost function classification means (e.g., cost function classification unit 227) which sets a label which is information that can identify contents of the learned cost function. Then, the cost function classification means may set the label indicating the contents of the feature with the highest weight to the learned cost function.

The data extraction means 73 may extract training data of a person who satisfies the predefined conditions of an expert.

The function input means 71 may accept input for the cost function where the longer the moving time, the higher the cost is calculated and the higher the evaluation of the travel point, the lower the cost is calculated.

A part of or all of the above exemplary embodiments may also be described as, but not limited to, the following supplementary notes.

(Supplementary note 1) A planning assistance system comprising:
a function input means which accepts input of a cost function that calculates a cost incurred by an itinerary, the cost function being expressed as a linear sum of terms weighted for each feature that a traveler is expected to intend in the itinerary;
a learning means which learns the cost function by inverse reinforcement learning using training data that includes scheduled information indicating travel planning of the traveler, attribute information indicating an attribute of the traveler, and actual information indicating an actual travel result of the traveler; and
a data extraction means which extracts the training data whose specified attribute matches the attribute information,
wherein the learning means learns the cost function according to the attributes by inverse reinforcement learning using the extracted training data.

(Supplementary note 2) The planning assistance system according to Supplementary note 1, further comprising:
a condition input means which accepts input of a constraint condition for generating the travel planning; and
a travel planning generating means which generates the travel planning with the minimum cost calculated by the cost function among the travel planning set up to travel to each candidate travel point to satisfy the constraint condition.

(Supplementary note 3) The planning assistance system according to Supplementary note 2, wherein
the travel planning generating means generates the travel planning by seeking a combination of move or stay with the minimum total cost based on the set of the candidate travel points and the cost incurred in moving to or staying at the candidate travel points calculated by the cost function.

(Supplementary note 4) The planning assistance system according to Supplementary note 2 or 3, further comprising
a travel planning output means which outputs move information between each travel point included in the travel planning superimposed on a map.

(Supplementary note 5) The planning assistance system according to any one of Supplementary notes 1 to 4, further comprising a learning result output means which outputs a feature included in the cost function and weight of the feature in correspondence with the weight of the feature.

(Supplementary note 6) The planning assistance system according to any one of Supplementary notes 1 to 5, further comprising a cost function classification means which sets a label which is information that can identify contents of the learned cost function;
wherein the cost function classification means sets the label indicating the contents of the feature with the highest weight to the learned cost function.

(Supplementary note 7) The planning assistance system according to any one of Supplementary notes 1 to 6, wherein
the data extraction means which extracts training data of a person who satisfies the predefined conditions of an expert.

(Supplementary note 8) The planning assistance system according to any one of Supplementary notes 1 to 7, wherein
the function input means accepts input for the cost function where the longer the moving time, the higher the cost is calculated and the higher the evaluation of the travel point, the lower the cost is calculated.

(Supplementary note 9) A planning assistance method comprising:
accepting input of a cost function that calculates a cost incurred by an itinerary, the cost function being expressed as a linear sum of terms weighted for each feature that a traveler is expected to intend in the itinerary;
learning the cost function by inverse reinforcement learning using training data that includes scheduled information indicating travel planning of the traveler, attribute information indicating an attribute of the traveler, and actual information indicating an actual travel result of the traveler;
extracting the training data whose specified attribute matches the attribute information; and
learning the cost function according to the attributes by inverse reinforcement learning using the extracted training data.

(Supplementary note 10) The planning assistance method according to Supplementary note 9, further comprising:
accepting input of a constraint condition for generating the travel planning; and
generating the travel planning with the minimum cost calculated by the cost function among the travel planning set up to travel to each candidate travel point to satisfy the constraint condition.

(Supplementary note 11) A program storage medium storing a planning assistance program for causing a computer to execute:
function input processing to accept input of a cost function that calculates a cost incurred by an itinerary, the cost function being expressed as a linear sum of terms weighted for each feature that a traveler is expected to intend in the itinerary;
learning processing to learn the cost function by inverse reinforcement learning using training data that includes scheduled information indicating travel planning of the traveler, attribute information indicating an attribute of the traveler, and actual information indicating an actual travel result of the traveler; and
data extraction processing to extract the training data whose specified attribute matches the attribute information,
wherein, in the learning processing, the cost function is learned according to the attributes by inverse reinforcement learning using the extracted training data.

(Supplementary note 12) The program storage medium according to Supplementary note 11, that stores the planning assistance program for causing a computer to further execute:
condition input processing to accept input of a constraint condition for generating the travel planning; and
travel planning generating processing to generate the travel planning with the minimum cost calculated by the cost function among the travel planning set up to travel to each candidate travel point to satisfy the constraint condition.

(Supplementary note 13) A planning assistance program for causing a computer to execute:
function input processing to accept input of a cost function that calculates a cost incurred by an itinerary, the cost function being expressed as a linear sum of terms weighted for each feature that a traveler is expected to intend in the itinerary;
learning processing to learn the cost function by inverse reinforcement learning using training data that includes scheduled information indicating travel planning of the traveler, attribute information indicating an attribute of the traveler, and actual information indicating an actual travel result of the traveler; and
data extraction processing to extract the training data whose specified attribute matches the attribute information,
wherein, in the learning processing, the cost function is learned according to the attributes by inverse reinforcement learning using the extracted training data.

(Supplementary note 14) The planning assistance program according to Supplementary note 13, that stores the planning assistance program for causing a computer to further execute:
condition input processing to accept input of a constraint condition for generating the travel planning; and
travel planning generating processing to generate the travel planning with the minimum cost calculated by the cost function among the travel planning set up to travel to each candidate travel point to satisfy the constraint condition.

Although the present invention has been explained above with reference to the exemplary embodiments, the present invention is not limited to the above exemplary embodiments. Various changes can be made to the configuration and details of the present invention that can be understood by those skilled in the art within the scope of the present invention.

### REFERENCE SIGNS LIST

1, 2 Travel planning assistance system
10 Travel history storage device
40 Display device
120, 220 Learning device
121 Attribute input unit
122 Cost function input unit
123, 223 Data extraction unit
124, 224 Inverse reinforcement learning unit
125 Learning result output unit
126 Storage unit
130, 230 Travel planning output device
131 Condition input unit
132 Travel planning generating unit
133 Travel planning output unit
134 Storage unit
227 Cost function classification unit
234 Cost function selection unit

What is claimed is:

1. A planning assistance system comprising:
a memory storing instructions; and
one or more processors configured to execute the instructions to:
accept input of a cost function that calculates a cost incurred by an itinerary, the cost function being expressed as a linear sum of terms weighted for each feature that a traveler is expected to intend in the itinerary;
learn the cost function by inverse reinforcement learning using training data that includes scheduled information indicating travel planning of the traveler, attribute information indicating an attribute of the traveler, and actual information indicating an actual travel result of the traveler;
extract the training data whose specified attribute matches the attribute information; and
learn the cost function according to the attributes by inverse reinforcement learning using the extracted training data.

2. The planning assistance system according to claim 1, wherein the processor is configured to execute the instructions to:
accept input of a constraint condition for generating the travel planning; and
generate the travel planning with the minimum cost calculated by the cost function among the travel planning set up to travel to each candidate travel point to satisfy the constraint condition.

3. The planning assistance system according to claim 2, wherein the processor is configured to execute the instructions to generate the travel planning by seeking a combination of move or stay with the minimum total cost based on the set of the candidate travel points and the cost incurred in moving to or staying at the candidate travel points calculated by the cost function.

4. The planning assistance system according to claim 2, wherein the processor is configured to execute the instructions to output move information between each travel point included in the travel planning superimposed on a map.

5. The planning assistance system according to claim 1, wherein the processor is configured to execute the instructions to output a feature included in the cost function and weight of the feature in correspondence with the weight of the feature.

6. The planning assistance system according to claim 1, wherein the processor is configured to execute the instructions to:
set a label which is information that can identify contents of the learned cost function, function; and
set the label indicating the contents of the feature with the highest weight to the learned cost function.

7. The planning assistance system according to claim 1, wherein the processor is configured to execute the instructions to extract training data of a person who satisfies the predefined conditions of an expert.

8. The planning assistance system according to claim 1, wherein the processor is configured to execute the instructions to accept input for the cost function where the longer the moving time, the higher the cost is calculated and the higher the evaluation of the travel point, the lower the cost is calculated.

9. A planning assistance method comprising:
accepting input of a cost function that calculates a cost incurred by an itinerary, the cost function being expressed as a linear sum of terms weighted for each feature that a traveler is expected to intend in the itinerary;
learning the cost function by inverse reinforcement learning using training data that includes scheduled information indicating travel planning of the traveler, attribute information indicating an attribute of the traveler, and actual information indicating an actual travel result of the traveler;
extracting the training data whose specified attribute matches the attribute information; and
learning the cost function according to the attributes by inverse reinforcement learning using the extracted training data.

10. The planning assistance method according to claim 9, further comprising:
accepting input of a constraint condition for generating the travel planning; and
generating the travel planning with the minimum cost calculated by the cost function among the travel planning set up to travel to each candidate travel point to satisfy the constraint condition.

11. A non-transitory computer readable information recording medium storing a planning assistance program for causing a computer to execute:
function input processing to accept input of a cost function that calculates a cost incurred by an itinerary, the cost function being expressed as a linear sum of terms weighted for each feature that a traveler is expected to intend in the itinerary;
learning processing to learn the cost function by inverse reinforcement learning using training data that includes scheduled information indicating travel planning of the traveler, attribute information indicating an attribute of the traveler, and actual information indicating an actual travel result of the traveler; and
data extraction processing to extract the training data whose specified attribute matches the attribute information,
wherein, in the learning processing, the cost function is learned according to the attributes by inverse reinforcement learning using the extracted training data.

12. The non-transitory computer readable information recording medium according to claim 11, that stores the planning assistance program for causing a computer to further execute:
condition input processing to accept input of a constraint condition for generating the travel planning; and
travel planning generating processing to generate the travel planning with the minimum cost calculated by the cost function among the travel planning set up to travel to each candidate travel point to satisfy the constraint condition.
